(19) United States
(12) Patent Application Publication
(10) Pub. No.: US 2013/0006754 A1
(43) Pub. Date: Jan. 3, 2013

(54) MULTI-STEP IMPRESSION CAMPAIGNS

(75) Inventors: Eric Horvitz, Kirkland, WA (US); Lili Cheng, Bellevue, WA (US); Roger Barga, Bellevue, WA (US); Xuedong Huang, Bellevue, WA (US); Zachary Apter, Seattle, WA (US); Semiha Ece Kamar, Kirkland, WA (US)

(73) Assignee: MICROSOFT CORPORATION, Redmond, WA (US)

(21) Appl. No.: 13/174,329

(22) Filed: Jun. 30, 2011

(51) Int. Cl. G06Q 30/00

(52) U.S. Cl. 705/14.43; 705/14.66; 705/14.58; 705/14.41

(57) ABSTRACT

Various embodiments are described for computerized advertising systems and methods. The system may include an ad server that includes an impression campaign engine configured to associate a target user profile with a plurality of computing devices. The ad server is also configured to receive a multi-step impression plan including a plurality of triggers from an advertiser. Each trigger is associated with a different advertisement to be served to at least one of the plurality of devices. The system also includes an ad serving engine configured to serve a first advertisement to a first device in response to making an inference from sensors or detecting a first trigger, and a second advertisement to a second device in response to a second inference or detecting a second trigger, according to the impression plan. A predictive model developed from machine learning may be used to develop a learning-based multi-step impression plan.

### BACKGROUND

An individual may use multiple computing devices, such as a desktop computer, notebook computer, tablet computer, mobile communication device, interactive television, gaming system, etc. An advertiser may design an advertising campaign that serves ads to an individual computing device upon receiving ad requests from the device. Ads are targeted to the user of the device based on, for example, search queries received from the user, contextual keywords contained in a web page in which the advertisement is displayed, or a transaction history of the user at an e-commerce marketplace, as some examples. One drawback with current online advertising technologies is that a user may be presented with the same ad multiple times, on one or more devices, which may lead to the user ignoring the ads, thereby reducing the effectiveness of the advertising campaign. To again capture the user's attention, the advertiser may wish to display a second, different advertisement to the user. However, using current advertising technologies, the advertiser must implement a second advertising campaign, which results in the second advertisement being displayed to all users. This can cause many users to miss the first advertisement if they didn't access a website serving the first ad during the time period of the first ad campaign. If the advertisements are presented in a sequence, users who missed the first advertisement may not fully understand a later advertisement. As a result, the effectiveness of the advertisements served in this manner may be diminished.

### SUMMARY

To address the above issues, computerized advertising systems and methods are provided for multi-step ad campaigns. The system may comprise an ad server including an advertising campaign engine that is configured to associate a target user profile with a plurality of computing devices. The advertising campaign engine is also configured to receive a multi-step advertising plan from an advertiser, with the advertising plan including a plurality of different triggers for the target user profile. Each of the triggers may be associated with a different advertisement to be served to at least one of the plurality of devices for the target user profile.

The system may also include an ad serving engine that is configured to, in response to detecting a first trigger associated with the target user profile, serve a first advertisement to a first device associated with the target user profile and according to the advertising plan. The ad serving engine is also configured to, in response to detecting a second trigger associated with the target user profile, serve a second advertisement to a second device associated with the target user profile, according to the advertising plan.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view of a computerized advertising system according to an embodiment of the present disclosure.

FIG. 2 is a schematic view of a flow chart depicting a method for implementing an advertising plan according to an embodiment of the present disclosure.

FIG. 3 is a continuation of the flow chart of FIG. 2.

FIG. 4 is a schematic view of a diagram illustrating a use case of the computerized advertising system of FIG. 1.

FIG. 5 is a detail flow chart depicting an exemplary method for accomplishing the step of aggregating data for machine learning in FIG. 2.

### DETAILED DESCRIPTION

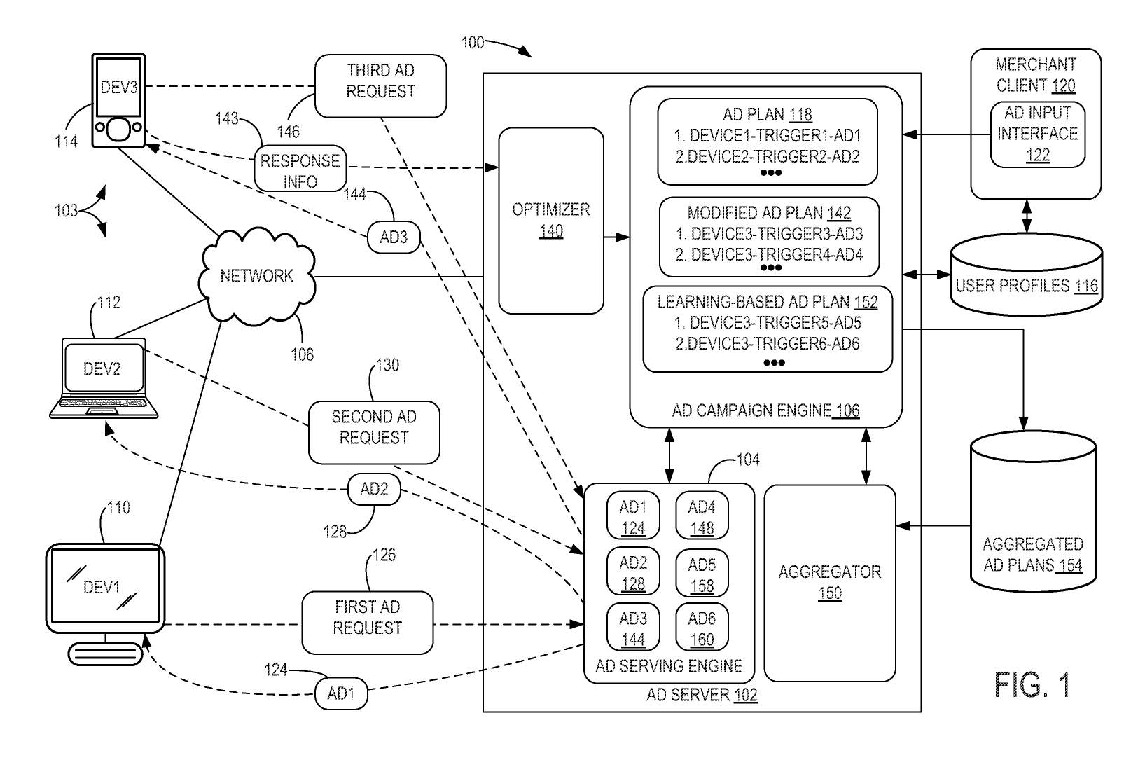

FIG. 1 shows a schematic view of a computerized advertising system 100 that includes an ad server 102, an ad serving engine 104 and an ad campaign engine 106. In the following description, the ad serving engine 104 and ad campaign engine 106 are described as executed on an ad server 102. It will be appreciated that ad server 102 may be implemented as one or more coordinated servers, which may be co-located in a server farm or distributed in multiple different locations, as desired.

The ad server 102 may communicate with a plurality of computing devices 103 via a network 108. In one example, the computing devices 103 may take the form of a desktop computing device 110, a mobile computing device 112 such as a laptop or notebook computer, a mobile communication device 114, or other suitable type of computing device. Other suitable computing devices may include, but are not limited to, tablet computers, home entertainment computers, interactive televisions, gaming systems, navigation systems, portable media players, etc. Additionally, the network 108 may take the form of a local area network (LAN), wide area network (WAN), wired network, wireless network, personal area network, or a combination thereof, and may include the Internet.

Each of the computing devices 103 may be owned and/or used by the same user. The user may utilize these devices for a variety of functions and to access various services across the network 108. Such services may include, but are not limited to, search services, email services, e-commerce services, document server services, web applications, etc. As the user accesses these services across the network 108, a cross-service user profile may be generated over time. The user profile may include, for example, demographic information, product, service and application preferences, entertainment interests, network user IDs, device information, location information, location trajectory information, information about the dwells and pauses at locations, etc. The user profile may also include information related to products and services in which a user has expressed or implied an interest, such as through searching activity, and information and/or statistics related to a user's prior purchasing history, including the user's responses to previous advertisements for particular products or services, such as click through rates, purchase rates, view through rates, pauses at locations that provide evidence of engaging in a service or purchasing a product, etc. User profiles for multiple users across the network 108 may be stored in a user profile database 116.

An advertiser may desire to implement a multi-step promotional campaign as a plan that is directed to a target user profile. A merchant client 120 associated with the advertiser includes an ad input interface 122 that is configured to deliver a multi-step advertising plan 118 directed to a target user profile to the ad campaign engine 106. The ad campaign engine 106 is configured to associate the target user profile with a plurality of computing devices that are owned and/or used by the same user. In one example, the ad campaign engine 106 associates the target user profile with the desktop computing device 110 (device 1), the mobile computing device 112 (device 2), and the mobile communication device 114 (device 3) that are each owned and/or used by a user matching the target user profile.

The multi-step advertising plan 118 includes a plurality of different triggers for the target user profile. Each of the triggers is associated with a different advertisement to be served to at least one of the computing devices 103, such as the desktop computing device 110, the mobile computing device 112, and/or the mobile communication device 114. As explained in more detail below, the triggers are arranged in sequence such that different advertisements are delivered in a coordinated fashion to the same device or to different devices.

The advertisements to be served according to the advertising plan 118 may be displayed on the different computing devices 103, including the desktop computing device 110, the mobile computing device 112, and/or the mobile communication device 114, in different media formats. Such formats may include, but are not limited to, audio, video, image, text and animation.

The advertising plan 118 includes a first step of delivering a first ad, such as ad1, shown at 124, to a first device, such as desktop computing device 110 (device1). The ad1 may be delivered by the ad serving engine 104 upon the ad serving engine receiving a first ad request 126 from the desktop computing device 110, and upon detecting one or more triggers associated with the target user profile. The first ad request 126 may be sent by the desktop computing device 110 when the user engages in activities on the desktop computing device via the network 108, such as, for example, launching an application, accessing a web service, loading a web page, sending a search query, etc. The first ad request 126 also includes information related to the user of desktop computing device 110. Such information may include, but is not limited to, a network user ID, location information, device type information, keyword information, etc.

The one or more triggers associated with the target user profile may include a time and/or a date trigger. As one example, the first step in advertising plan 118 may include delivering ad1 in the form of a text ad for a business such as Florist A to desktop computing device 110 (device1). A first trigger (trigger1) of the first step in advertising plan 118 is satisfied when the ad serving engine 104 receives a first ad request 126 within 30 days of Mother's Day. It will be appreciated that many other timeframes and date ranges, including times of day or windows of time within a day, and combinations of the foregoing, may also be used as time and/or date triggers. In another example, one or more additional triggers for the first step in advertising plan 118 may also be included, such as requiring that the ad request 126 include a search keyword of “flower”, “florist”, “mother's day”, “mom”, or “gift”.

The second step in advertising plan 118 may include a second trigger (trigger2), and may include sending a second ad2, shown at 128, in a different media format to the mobile computing device 112 (device2). For example, the ad2 may be in the form of a video showing Mother's Day bouquets offered by Florist A. The second trigger may be satisfied when the following parameters have been met: 1) the desktop computing device 110 has displayed at least 3 impressions of ad1: and 2) the user has not visited the Florist A website. Upon the ad serving engine 104 receiving a second ad request 130 from the mobile computing device 112, and detecting that the second trigger has been satisfied, the ad serving engine 104 serves ad2 to the mobile computing device.

It will be appreciated that many other variations of triggers may be used in the steps of a multi-step advertising plan. In one example, a trigger may be a geographic trigger related to a location of a location-aware computing device. The location-aware computing device may determine its location by sensing one or more of GPS, Wi-Fi, and/or cell-tower radio signals, or by using other location-sensing modalities. In one use case example, a user of a location-aware smartphone is at an airport to pick up a friend. The user launches the browser on his smartphone and navigates to an airline website to check the status of his friend's flight. The smartphone sends an ad request to an ad serving engine that includes the user's current location at the airport. In response, the ad serving engine sends a text ad to the smartphone that includes a coupon for a free beverage at a coffee shop inside the airport.

In another example, the trigger is a behavioral trigger that is associated with historical data, contemporaneous data, or predictive data related to a user. Historical data related to a user may include, but is not limited to, previous location data and route data provided by location-aware devices, purchasing history and habits, search history, browsing history, etc. As an example, a behavioral trigger in an advertising campaign developed by a frozen yogurt shop may require that a target user has visited a frozen yogurt shop within the last 3 months. The target user has a location-aware device that includes location data and corresponding date/time data indicating that the device has been located at 1000 Main Street in Anytown, USA, on 6 of the previous 8 Friday evenings, for an average of 30 minutes per instance. Frozen Yogurt Shop B is located at 1000 Main Street in Anytown, USA. Thus, upon receiving an ad request from the user's device including this location and date/time data, this behavioral trigger may be detected and determined to have been satisfied.

Contemporaneous data related to a user may include, but is not limited to, data suggesting one or more current activities or contexts of the user. As an example, a user may launch a media player application on the user's mobile computing device and begin streaming an album by the band Bluegrass1 from a cloud-based music service. A behavioral trigger in an advertising campaign developed by a mandolin manufacturer may require that a user is currently listening to music within the bluegrass genre, in which the music of the band Bluegrass1 falls. Thus, upon receiving an ad request from the user's device including information that the user is currently streaming music by Bluegrass1, this behavioral trigger may be detected and determined to have been satisfied.

Predictive data related to a user may include, but is not limited to, data suggesting a user's future activities, locations, contexts, etc. As an example, a user may enter an appointment in her cloud-based calendar application via her smartphone for a Bluegrass1 concert at the Downtown Concert Hall next Friday at 7 pm. A behavioral trigger in an advertising campaign developed by Restaurant X may require that a user has an activity planned in the next two weeks between 5-9 pm, and occurring within a ½ mile radius of Restaurant X. The Downtown Concert Hall is within 2 blocks of Restaurant X. Thus, upon receiving an ad request from the user's device including information regarding her upcoming appointment/concert, this behavioral trigger may be detected and determined to have been satisfied. It will be appreciated that predictive data may also include or utilize historical data and/or contemporaneous data that may be examined to determine whether a behavioral trigger has been detected and satisfied.

With continued reference to FIG. 1, the computerized advertising system 100 may also include an optimizer 140 that is configured to modify the multi-step advertising plan 118 based on a measure of effectiveness of the plan. The measure of effectiveness may relate to a level of achievement of one or more goals included in the multi-step advertising plan 118. Goals may include, but are not limited to, a user making a purchase from an advertiser, visiting an advertiser's retail store, clicking through one or more ads from the advertiser, viewing a specified number of ad impressions, etc. With respect to the multi-step advertising plan 118, the goals may relate to collected response information received from the user regarding the user's response to ad1 124 and ad2 128. For example, a measure of effectiveness may be whether the user purchases an advertised product after the user clicks through ad1 and ad2 that are advertising the product. The optimizer 140 may receive collected response information from one or more of the computing devices 103, such as response information 143 from mobile computing device 114.

In one example, where a measure of effectiveness of the multi-step advertising plan 118 has not been achieved, the optimizer 140 is configured to create a modified ad plan 142. It will be appreciated that the modified ad plan 142 may be considered an extension to or a modification of the multi-step advertising plan 118, or may be considered a new ad plan targeted to the same user. In creating modified ad plan 142, the optimizer may modify ad1 and/or ad2 to create an ad3, shown at 144. In another example, ad3 may be a new ad selected or created by the optimizer 140. The optimizer 140 may also be configured to modify the first trigger (trigger1) or the second trigger (trigger2) of the multi-step advertising plan 118 to create a third trigger (trigger3). In another example, trigger3 may be a new trigger that is utilized in the modified ad plan 142. The optimizer 140 may also use additional user profile information, such as demographic information, and data gathered during execution of the multi-step advertising plan 118 to create the modified ad plan 142. Such data may include, for example, the user's response to ad1 124 and ad2 128 served in the multi-step advertising plan 118. The optimizer 140 may also create the modified ad plan 142 based at least in part on the type of computing device 103 that will receive an advertisement. For example, a visual advertisement may be desirable for the laptop computing device 112, while an audio advertisement may be desirable for the mobile communication device 114, particularly in a context where the user and device 114 are in motion.

In one example, a first step in modified ad plan 142 includes delivering ad3 144 in the form of modified text from ad1 124 plus a coupon for 25% off a Mother's Day bouquet from Florist A. By referencing the target user profile of the user associated with the desktop computing device 110, laptop computing device 112, and mobile communication device 114, the optimizer 140 may determine that the user uses the mobile communication device 114 (device3) much more frequently than the other two computing devices. The optimizer 140 may then design the modified ad plan 142 to cause the ad serving engine 104 to send ad3 to the mobile communication device 114 upon receiving a third ad request 146 from the mobile communication device, and upon detecting that a third trigger (trigger3) has been satisfied.

The second step in the modified ad plan 142 may include a fourth trigger (trigger4), and may include sending ad4, shown at 148, to the mobile communication device 144 (device3). It will be appreciated that ad4 may be served in the same manner as described above for ad1, ad2, and ad3. In one example, ad4 may be in the form of text modified from ad3 and may include a revised coupon offering 50% off Mother's Day bouquets offered by Fantastic Flowers. The fourth trigger (trigger4) may be satisfied when the following parameters have been met: 1) the mobile communication device 114 has displayed at least 3 impressions of ad3; and 2) the user has not used the coupon included with ad3.

The computerized advertising system 100 may also include an aggregator 150 that is configured to aggregate data for use in data-centric statistical analyses, aimed at constructing predictive models that can be used in the optimization of plans. Machine learning procedures, including but not limited to Bayesian structure search over a space of models that are scored using a measure such as the Bayesian information criterion (or approximations), Support Vector Machines, Gaussian Processes, and various forms of regression, including logistic regression models coupled with one or more feature selection methodologies, can be used to build models of the effectiveness of different kinds of single next actions and of the effectiveness of longer sequences of actions on different populations. Such models can be used in larger decision analyses that weigh the costs and benefits of different sequences for individuals and populations under inferred uncertainties and that are aimed at the optimization of multi-step advertising plan 152 based on aggregated data.

With machine learning, examples of different outcomes, such as the measured successes and failures of various kinds of impression plans, can be used to build classifiers that can predict the likelihood of the success and failures or the likelihood of other outcomes useful in designing impression plans. In developing the learning-based multi-step advertising plan 152, the aggregator 150 may access an aggregated advertising plan database 154 that contains aggregated data indicating the measured performance of multiple advertising plans over time. Such aggregated data may include data from advertising plans implemented by the ad campaign engine 106 and/or other advertising plans.

Furthermore, active sensing and learning methods may be used to automatically allocate and guide sensing and data collection, respectively, under limited resources and/or privacy concerns. With active sensing, the expected value of information is computed based on inferences made by the learned predictive models, and of evidence that is already observed. This expected value of information is used to compute the value of seeking to learn the value of unobserved information via extra sensing, or explicit engagement of one or more of a population of users. With active learning, expected value of information for the extension of predictive models is used to guide the collection of new data via sensing or explicit engagements with one or more people of a population which promises to enhance the performance of predictive models. Both the real-time active sensing, and longer-term active learning policies can be used to enhance impression plans.

In one example, the ad campaign engine 106 may receive an advertising plan from Florist A that includes a target user profile and ad5, shown at 158, and ad6, shown at 160, promoting Mother's Day bouquets. Using aggregated data from the aggregated advertising plan database 154, the aggregator 150 may develop a machine-learning—based multi-step advertising plan 152 for the target user profile that delivers ad5 158 and ad6 160 to the mobile communication device 114. The learning-based multi-step advertising plan 152 may include trigger5 and trigger6 that are arranged in sequence to deliver ad5 and ad6 in a coordinated manner.

With continued reference to FIG. 1, the computerized advertising system 100 described above could also be configured to implement a multi-step advertising plan that is directed to a single computing device associated with a target user profile. In one example, the multi-step advertising plan 118 may be designed to cause the ad serving engine 104 to serve both ad1 124 and ad2 128 to the desktop computing device 110 (device1). Using the functionality described above, the optimizer 140 may be configured to modify the multi-step advertising plan 118 directed to a single computing device based on a measurement of an effectiveness of the plan. In one example, the optimizer 140 may modify ad1 and/or ad2, which are served to the desktop computing device 110. In another example, the optimizer 140 may modify the first trigger1 and/or the second trigger2 to create a third trigger3 and fourth trigger4. In still another example, the optimizer 140 may cause the ad serving engine 104, in response to detecting a third trigger3, to serve ad3 to the desktop computing device 110. The optimizer 140 may also cause the ad serving engine 104, in response to detecting a fourth trigger4, to serve ad4 to the desktop computing device 110.

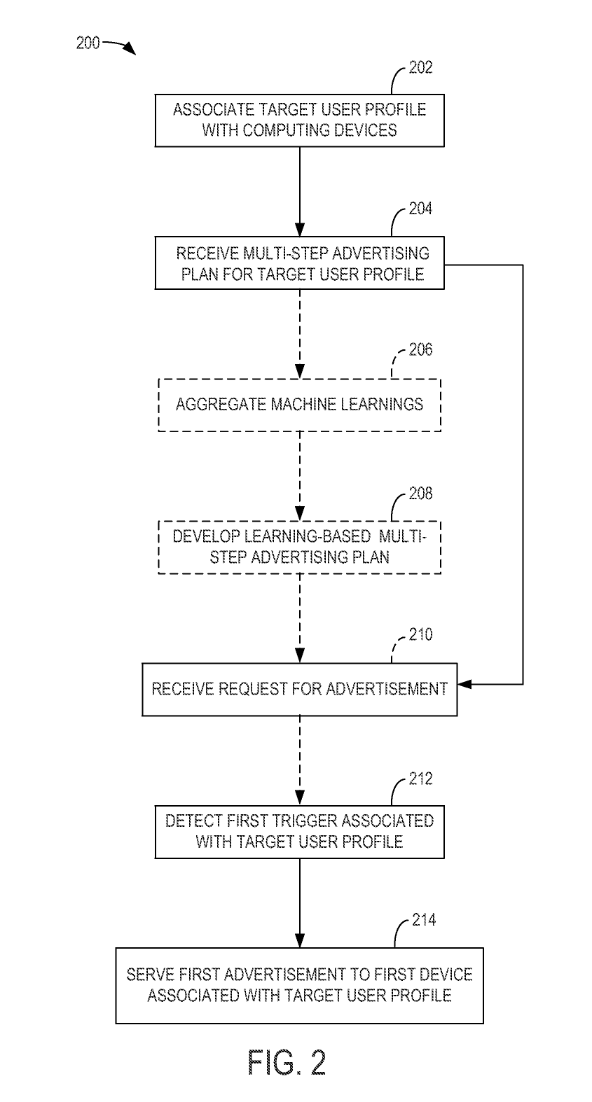

FIG. 2 illustrates a method 200 for implementing an advertising plan according to an embodiment of the present disclosure. The following description of method 200 is provided with reference to the software and hardware components of the computerized advertising system 100 described above and shown in FIG. 1. It will be appreciated that method 200 may be also performed in other contexts using other suitable hardware and software components.

At 202 the method includes associating a target user profile with a plurality of computing devices, such as the desktop computing device 110, the mobile computing device 112, and/or the mobile communication device 114. At 204 the method includes receiving a multi-step advertising plan 118 for the target user profile. The multi-step advertising plan 118 includes a plurality of different triggers that are arranged in a sequence for the target user profile. Each of the triggers is associated with a different advertisement to be served to the desktop computing device 110, the mobile computing device 112 and/or the mobile communication device 114.

In one example, at least one of the triggers may be a geographic trigger as described above. In another example, at least one of the triggers may be a time and/or date trigger as described above. In still another example, at least one of the triggers may be a behavioral trigger that includes historical data, contemporaneous data, and/or predictive data as described above.

At 206, the method may optionally include the step of aggregating data for machine learning gathered from other advertising plans. At 208, the method may then include developing a learning-based multi-step advertising plan based on the aggregated data. The method then proceeds, at 210, to receive a request for an advertisement from an advertiser. As noted above, the request may also include a location of at least one of the computing device 110, the mobile computing device 112 and/or the mobile communication device 114.

In another example, after receiving the multi-step advertising plan 118 for the target user profile at 204, the method may proceed to directly to 210 to receive the request for an advertisement. Next, at 212 the method includes detecting a first trigger, such as trigger1, that is associated with the target user profile. At 214 the method includes serving a first advertisement, such as ad1, to a first device associated with the target user profile, such as desktop computing device 110, according to the advertising plan.

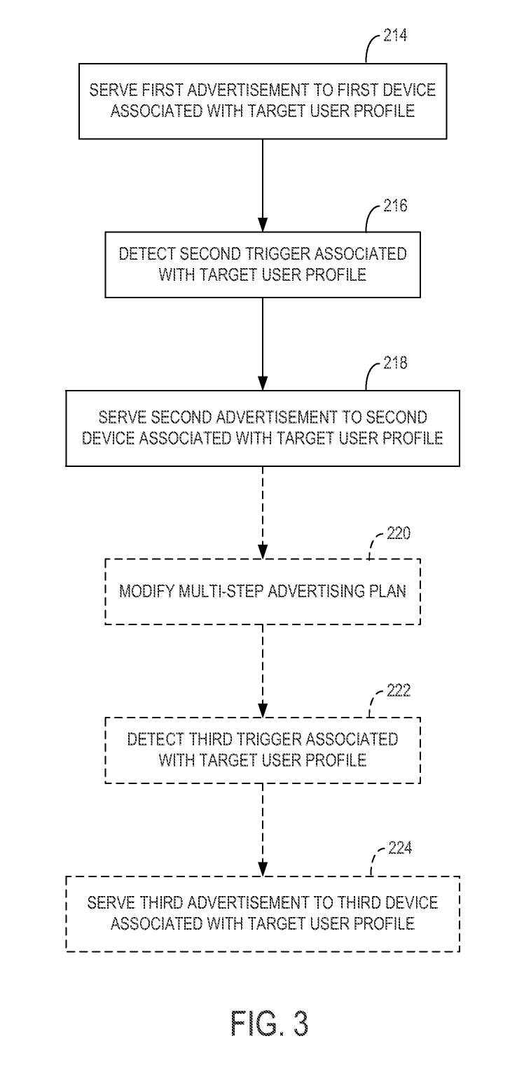

With reference now to FIG. 3, which is a continuation of the flow chart of FIG. 2, at 216 the method includes detecting a second trigger, such as trigger2, that is associated with the target user profile. At 218, the method includes serving a second advertisement, such as ad2 128, to a second device associated with the target user profile, such as mobile computing device 112, according to the advertising plan.

At 220, the method may optionally include modifying the multi-step advertising plan 118 based on a measurement of an effectiveness of the plan. As described above, modifying the multi-step advertising plan 118 may create a modified ad plan 142. At 222, the method includes detecting a third trigger, such as trigger3, that is associated with the target user profile. At 224, the method includes serving a third advertisement, such as ad3, to a third computing device associated with the target user profile, such as mobile communication device 114.

It will be appreciated that the functions and processes described with regard to method 200 may be accomplished as described above with regard to the computerized advertising system 100.

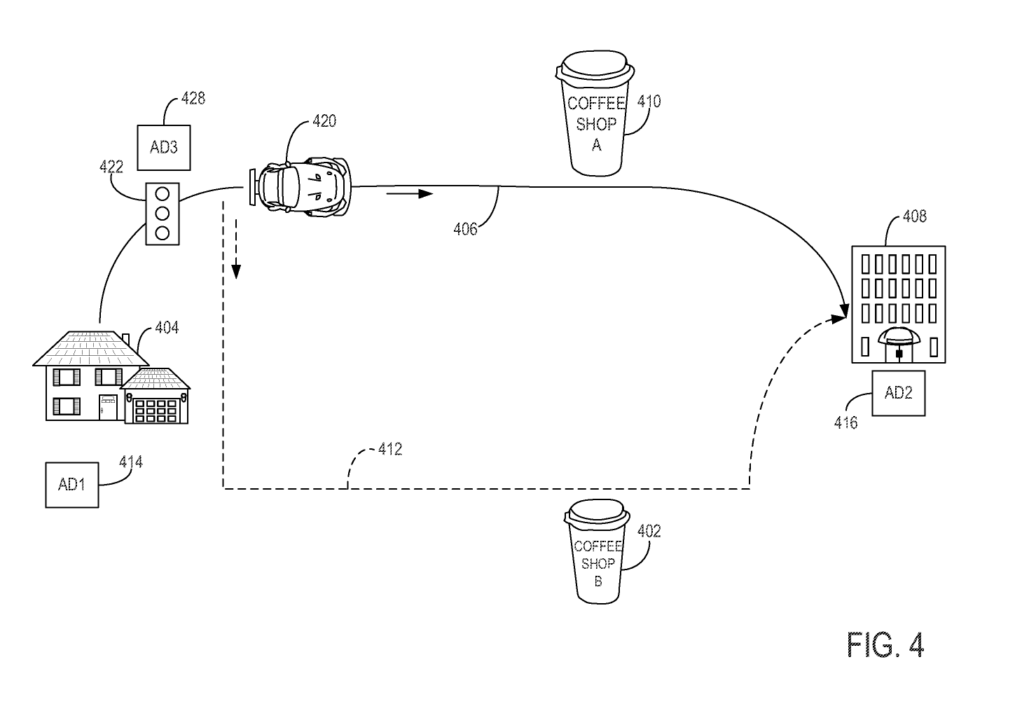

With reference now to FIG. 4, an example use case scenario of the computerized advertising system 100 will be described. In this use case, the First Cup coffee shop 402 provides a multi-step advertising campaign to the computerized advertising system 100 that targets a potential customer Jack, who lives in home 404. Through Jack's use of network resources via multiple computing devices, it is determined that Jack consistently travels the same route 406 between 7:00 am and 7:45 am on most weekday mornings to a location corresponding to the Bank Building 408. It is also determined that Jack regularly stops along this route 406 at a location corresponding to the address of Coffee Shop A, shown at 410. This information may be gathered, for example, from Jack's smartphone that includes GPS tracking functionality, and where Jack has opted-in to share this information with the network.

Coffee Shop B, shown at 402, may desire that Jack change his morning commute and take a different route 412 to the Bank Building 408. While route 412 will take Jack directly past the Coffee Shop A, it is also ½ mile longer than route 406. Coffee Shop B's advertising campaign is programmed according to a multi-step ad campaign to send a first ad 414 to Jack's desktop computer in his home 404. The first ad includes text along with a map highlighting the location of the Coffee Shop B 402.

After the desktop computer has displayed at least 5 impressions of the first ad, and provided that Jack has not visited the Coffee Shop B, the advertising campaign may send a second ad 416 to Jack's notebook computer, which it has been determined through geographic locating tools that he generally uses in the Bank Building 408. The second ad 416 is a text ad that includes a $1.00 off coupon for a beverage at the Coffee Shop B. Additionally, the second ad 416 is customized to provide driving directions along route 412 from Jack's home 404 past the Coffee Shop B to the Big Bank Building 408.

After Jack's notebook computer has displayed at least 3 impressions of the second ad 416, and provided that Jack has not redeemed the $1.00 off coupon, the advertising campaign may send a third ad 418 to Jack's smartphone that Jack carries in his car 420 on his daily commute to the Big Bank Building 408. The third ad 418 is a text ad that includes a coupon for a free beverage at the Coffee Shop B 402, along with audio that plays the Coffee Shop B jingle. Additionally, the third ad 418 is designed to be delivered to the smartphone on a weekday between 7 am and 7:45 am, and when the smartphone is stationary for more than 3 seconds at the location of stoplight 422, which suggests that Jack's car 420 is stopped at the stoplight 422. The third ad 418 is further customized to provide driving directions from the stoplight 422 along route 412 and past Coffee Shop B to the Bank Building 408. In this manner, Jack may be incentivized at an opportune moment to make the switch and journey to Coffee Shop B.

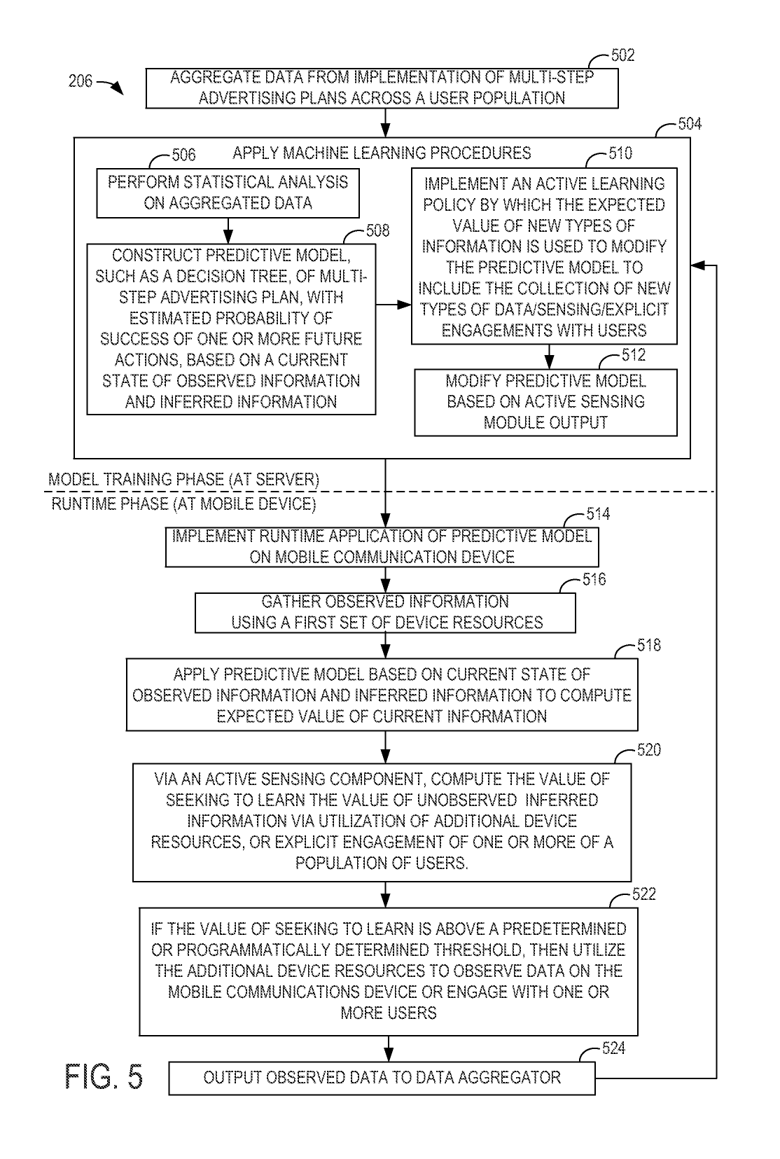

Turning now to FIG. 5, one example method is shown for aggregating data for machine learning gathered from other advertising plans, as discussed above at step 206 in FIG. 2. At 502, the method includes aggregating data from implementation of multi-step advertising plans across a user population. At 504, the method includes applying machine learning procedures. As discussed above, the machine learning procedures applied at 504 may include but are not limited to Bayesian structure search over a space of models that are scored using a measure such as the Bayesian information criterion (or approximations), Support Vector Machines, Gaussian Processes, and various forms of regression, including logistic regression models coupled with one or more feature selection methodologies. The machine learning procedures at 504 may include, as illustrated at 506, performing statistical analysis on the aggregated data, and as illustrated at 508, constructing a predictive model of multi-step advertising plans. The predictive model may include an estimated probability of success of one or more future actions, based on a current state of observed information and inferred information.

Applying the machine learning procedures may further include, as illustrated at 510, implementing an active learning policy by which the expected value of new types of information is used to modify the predictive model to include collections of the new types of data by utilizing additional device resources and/or explicit engagement of one or more users of the user population. At 512, the machine learning procedures may include modifying the modifying the predictive model based on output received from an active sensing module of the mobile computing device, as described below.

It will be appreciated that steps 502-512 comprise a predictive model training phase, and are typically implemented by a program executed on a server, such as by the aggregator of ad server 102 described above. The following steps 514-524 comprise a runtime phase of the method in which a predictive model outputted by the machine learning procedures is executed on a mobile computing device.

At 514, the method includes implementing a runtime application of the predictive model on a mobile communication device, such as those mobile communications devices described above. At 516, the method includes gathering observed information using a first set of device resources. It will be appreciated that “observed information” herein encompasses information detected from device resources such as GPS, processor, memory, applications, user data subject to privacy constraints, or other stored data or sensed data from sensors on the mobile communications device. Thus, an example of observed data is a GPS location that is detected by the GPS unit on the mobile communication device.

At 518, the method includes applying the predictive model based on a current state of observed information and inferred information to compute an expected value of current information known by observation and inference to the model. Herein, “inferred information” is meant to encompass information that is inferred based on the predictive model and the observed information.

It will be understood that the predictive model includes an active sensing component configured actively make decisions regarding whether additional device resources should be devoted to discovering additional information which might help inform the development advertising plans. As illustrated at 520 the method includes, via this active sensing component of the predictive model which is implemented at runtime, computing the value of seeking to learn the value of unobserved inferred information via utilization of additional device resources or explicit engagement of one or more of the user population. It will be understood that by “engagement” is meant an explicit query of the user, for example, to authorize the use of data, such as current GPS coordinates of the mobile communications device, which may be subject to privacy controls, or to inquire of the user whether the user has engaged in a particular action, such as purchasing a product for which an advertising plan was implemented.

At 522, if the value of seeking to learn is above a predetermined or programmatically determined threshold, then the method includes utilizing the additional device resources to observe data on the mobile communications device or engage with one or more of the user population. At 524, the observed information from steps 516 and 522, if applicable, are outputted to the data aggregator of the server 120, and used to modify the predictive model based on active sensing output, as described above at step 512.

The predictive model developed from machine learning based on aggregated data in this manner may be used to develop a learning-based multi-step advertising plan at step 208 described above, which is of improved efficiency.

It will be appreciated that the above described systems and methods may be utilized to design and/or implement multi-step advertising campaigns that deliver ads to multiple computing devices associated with a user. The above described systems and methods may also be utilized to modify an advertising campaign based on a real-time measurement of an effectiveness of the campaign.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed. Although the systems and methods are described with reference to multi-step advertising plans according to which a plurality of advertisements may be delivered, it will be appreciated that promotional campaigns such as coupon campaigns, informational campaigns, etc., may be implemented using these systems and methods. The term “advertisement” as used herein is broadly meant to encompass these various advertising types. Further, it will be understood that the terms impression plan and advertising plan are used interchangeably herein.

The subject matter of the present disclosure includes all novel and nonobvious combinations and subcombinations of the various processes, systems and configurations, and other features, functions, acts, and/or properties disclosed herein, as well as any and all equivalents thereof.

1. A computerized advertising system, comprising:
an ad server including an advertising campaign engine configured to associate a target user profile with a plurality of computing devices, and configured to receive from an advertiser a multi-step advertising plan, the advertising plan including a plurality of different triggers for the target user profile, each trigger being associated with a different advertisement to be served to at least one of the plurality of devices for the target user profile; and
an ad serving engine configured to:
in response to detecting a first trigger associated with the target user profile, serve a first advertisement to a first device associated with the target user profile, according to the advertising plan; and
in response to detecting a second trigger associated with the target user profile, serve a second advertisement to a second device associated with the target user profile, according to the advertising plan.

2. The computerized advertising system of claim 1, wherein the plurality of different triggers are arranged in sequence.

3. The computerized advertising system of claim 1, wherein at least one of the plurality of different triggers is a geographic trigger, and wherein at least one of the first and second devices is location-aware and is configured to send its location to the ad server when requesting an advertisement.

4. The computerized advertising system of claim 1, wherein at least one of the plurality of different triggers is a time and/or a date trigger.

5. The computerized advertising system of claim 1, wherein at least one of the plurality of different triggers is a behavioral trigger.

6. The computerized advertising system of claim 5, wherein the behavioral trigger includes data selected from the group consisting of historical data, contemporaneous data, and predictive data.

7. The computerized advertising system of claim 1, further comprising an optimizer configured to modify the multi-step advertising plan based on a measurement of an effectiveness of the multi-step advertising plan.

8. The computerized advertising system of claim 1, further comprising an aggregator configured to aggregate machine learning gathered from other advertising plans and to develop a learning-based multi-step advertising plan based on the machine learning.

9. A computerized advertising system, comprising:
an ad server including an advertising campaign engine configured to associate a target user profile with a computing device, and configured to receive from an advertiser a multi-step advertising plan, the multi-step advertising plan including a plurality of different triggers for the target user profile, each trigger being associated with a different advertisement to be served to the computing device for the target user profile;
an ad serving engine configured to:
in response to detecting a first trigger associated with the target user profile, serve a first advertisement to the computing device associated with the target user profile, according to the advertising plan; and
in response to detecting a second trigger associated with the target user profile, serve a second advertisement to the computing device associated with the target user profile, according to the advertising plan; and
an optimizer configured to modify the multi-step advertising plan based on a measurement of an effectiveness of the multi-step advertising plan.

10. The computerized advertising system of claim 9, wherein the optimizer is configured to modify the first advertisement and/or the second advertisement in the advertising plan.

11. The computerized advertising system of claim 9, wherein the optimizer is configured to modify the first trigger and/or the second trigger in the advertising plan.

12. The computerized advertising system of claim 9, wherein the optimizer is configured to modify the multi-step advertising plan to cause the ad serving engine, in response to detecting a third trigger associated with the target user profile, to serve a third advertisement to the computing device associated with the target user profile.

13. A method for implementing an advertising plan, comprising:
associating a target user profile with a plurality of computing devices;
receiving from an advertiser a multi-step advertising plan including a plurality of different triggers arranged in a sequence for the target user profile, each of the triggers being associated with a different advertisement to be served to at least one of the plurality of computing devices for the target user profile;
detecting a first trigger associated with the target user profile;
serving a first advertisement to a first device associated with the target user profile, according to the advertising plan;
detecting a second trigger associated with the target user profile; and
serving a second advertisement to a second device associated with the target user profile, according to the advertising plan.

14. The method of claim 13, wherein at least one of the plurality of different triggers is a geographic trigger, and wherein at least one of the first and second devices is location-aware, further comprising receiving a request for an advertisement and a location of the at least one of the first and second devices.

15. The method of claim 13, wherein, wherein at least one of the plurality of different triggers is a time and/or a date trigger.

16. The method of claim 13,
wherein at least one of the plurality of different triggers is a behavioral trigger; and
wherein the behavioral trigger includes data selected from the group consisting of historical data, contemporaneous data, and predictive data.

17. The method of claim 13, further comprising modifying the multi-step advertising plan based on a measurement of an effectiveness of the multi-step advertising plan.

18. The method of claim 14, further comprising:
aggregating machine learning gathered from other advertising plans; and
developing a learning-based multi-step advertising plan based on the machine learning.

19. The method of claim 18, wherein aggregating machine learning is accomplished at least in part by:
aggregating data from implementation of multi-step advertising plans across a user population;
applying machine learning procedures including:
performing statistical analysis on the aggregated data; and
constructing a predictive model of multi-step advertising plans, the predictive model including an estimated probability of success of one or more future actions, based on a current state of observed information and inferred information.

20. The method of claim 19, wherein applying machine learning procedures further includes:
implementing an active learning policy by which the expected value of new types of information is used to modify the predictive model to include collections of the new types of data by utilizing additional device resources and/or explicit engagement of one or more users of the user population;
wherein the predictive model includes an active sensing component which is configured, at runtime, to compute the value of seeking to learn the value of unobserved inferred information via utilization of additional device resources or explicit engagement of one or more of the user population, and if the value of seeking to learn is above a predetermined or programmatically determined threshold, then utilize the additional device resources to observe data on the mobile communications device or engage with one or more of the user population;
the method further including modifying the predictive model based on output received from an active sensing module of the mobile computing device.
